(19) United States
(12) Patent Application Publication
(10) Pub. No.: US 2006/0112015 A1
(43) Pub. Date: May 25, 2006

(54) Method, system, and device for handling creation of derivative works and for adapting rights to derivative works

(75) Inventors: Robert Chancellor, Ladera Ranch, CA (US); Thomas Demartini, Culver City, CA (US); Mai Nguyen, Buena Park, CA (US); Xin Wang, Torrance, CA (US)

Correspondence Address: NIXON PEABODY, LLP, 401 9TH STREET, NW, SUITE 900, WASHINGTON, DC, 20004-2128, US

(73) Assignee: ContentGuard Holdings, Inc., Wilmington, DE (US)

(21) Appl. No.: 10/995,425

(22) Filed: Nov. 24, 2004

(51) Int. Cl. G06F 17/60

(52) U.S. Cl. 705/51

(57) ABSTRACT

A method, system, and device for handling creation of derivative works and for assigning usage rights to the derivative works for enforcing usage rights associated with digital works, including detecting computer-related events that are indicative of manipulations of an original work for creating a derivative work; and maintaining a history of information, including at least one of rights associated with electronic content related to each of the events, origin of electronic content related to each of the events, and event related information that can be used to determine the origin of and rights associated with electronic content.

### BACKGROUND OF THE INVENTION

1. Field of the Invention

The present invention generally relates to the field of digital rights management, and more particularly to a method, system, and device for handling creation of derivative works and for adapting rights to the derivative works.

2. Discussion of the Background

Digital Rights Management (DRM) systems and methods can take many forms and can be implemented in a variety of ways. A common aspect of protecting a work through the use of DRM is to determine and associate rights to the work, wherein such rights can be used express who may use the work and how the work may be used. With respect to derivative works, when an electronic work is adapted in such a way as to derive another electronic work, any suitable rights governing the use of the first electronic work may need to be maintained or changed in order to properly govern the use of the derivative work. If, for example, a user copies a protected image from one electronic work, and pastes the copied image into a derivative work, any suitable rights associated with the derivative work might need to be altered to make sure that the rights associated with the copied image are properly respected within the derivative work. Otherwise, pirating of protected content becomes simply a matter of copying rights-governed content from one electronic work to another. However, current DRM systems and methods are deficient with respect to handling creation of derivative works and adapting rights for the derivative works.

### SUMMARY OF THE INVENTION

Therefore, there is a need for a method, system, and device that addresses the above and other problems with conventional Digital Rights Management (DRM) systems, and methods. The above and other needs are addressed by the exemplary embodiments of the present invention, which provide a method, system, and device for adapting rights for derivative works. The exemplary embodiments include employing rights and origin information about derivation events to assign rights to derivative works. In order to make the rights and origin information available, the detecting of events and the tracking of the rights and origin information are performed. The exemplary embodiment, thus, can include intercepting or detecting derivation events associated with a derivative work, tracking rights and origin information associated with the derivation events, and arbitrating rights for the derivative work based on the derivation events and the rights and origin information.

Accordingly, in exemplary aspects of the present invention, a method, system, and device for handling creation of derivative works and for assigning usage rights to the derivative works for enforcing usage rights associated with digital works are provided, including detecting computer-related events that are indicative of manipulations of an original work for creating a derivative work; and maintaining a history of information, including at least one of rights associated with electronic content related to each of the events, origin of electronic content related to each of the events, and event related information that can be used to determine the origin of and rights associated with electronic content.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates generation of a derivative electronic work, wherein appropriate rights can be determined for and associated with the derivative electronic work;

FIGS. 2A-2D illustrate exemplary systems for adapting rights for derivative works;

FIG. 3 is used to illustrate exemplary processes performed by an exemplary event detector of the exemplary systems of FIGS. 2A-2D;

FIG. 4 is used to illustrate exemplary processes performed by an exemplary event tracker of the exemplary systems of FIGS. 2A-2D;

FIGS. 5A-5B are used to illustrate exemplary processes performed by an exemplary rights arbitrator and rights enforcer of the exemplary systems of FIGS. 2A-2D;

FIG. 6 is used to illustrate how rights are applied to an entire electronic document;

FIG. 7 is used to illustrate how rights are applied to an entire electronic image;

FIGS. 8A-8B are used to illustrate embedding of the electronic image of FIG. 7 into the electronic document of FIG. 6;

FIG. 9 is used to illustrate how derivative rights are generated for a derivative work corresponding to FIG. 6-8;

FIG. 10 is used to illustrate how further derivative rights are generated for a derivative work based on FIG. 9; and

FIG. 11 illustrates an exemplary system for adapting rights for derivative works and which can be used with the exemplary embodiments of FIGS. 1-10.

### DETAILED DESCRIPTION OF THE PREFERRED EMBODIMENTS

The present invention includes recognition that when an electronic work is adapted in such a way as to derive another electronic work, any suitable rights governing the use of the first electronic work may need to be maintained or changed in order to properly govern the use of the derivative work. If, for example, a user copies a protected image from one electronic work, and pastes the copied image into a derivative work, any suitable rights associated with the derivative work might need to be altered to make sure that the rights associated with the copied image are properly respected within the derivative work. Otherwise, pirating of protected content becomes simply a matter of copying rights-governed content from one electronic work to another.

The exemplary embodiments provide a solution to the above and other problems by adapting rights for derivative works, and which can be implemented in software and/or hardware, wherein rights and origin information regarding derivation events to assign rights to the derivative works are employed, including detecting the derivation events and tracking the rights and origin information. The exemplary embodiments, thus, can include logical modules for intercepting or detecting events, tracking rights and origin information about the derivation events, and arbitrating rights for the derivative work using such information.

In an exemplary embodiment, a derivative work can include an electronic work that is based partially or in whole on a pre-existing electronic work. The derivative work can be derived by creating a new electronic work and transferring content from a pre-existing electronic work into the new electronic work or derivative work can be derived by modifying a pre-existing electronic work. The derivative work can be the same physical file as the pre-existing electronic work or the derivative work can be a new file including portions of one or more pre-existing electronic works.

The exemplary embodiments include assigning appropriate rights, such as usage rights, to a derivative work and which are consistent with any suitable rights associated with the original work or works corresponding to the derivative work.

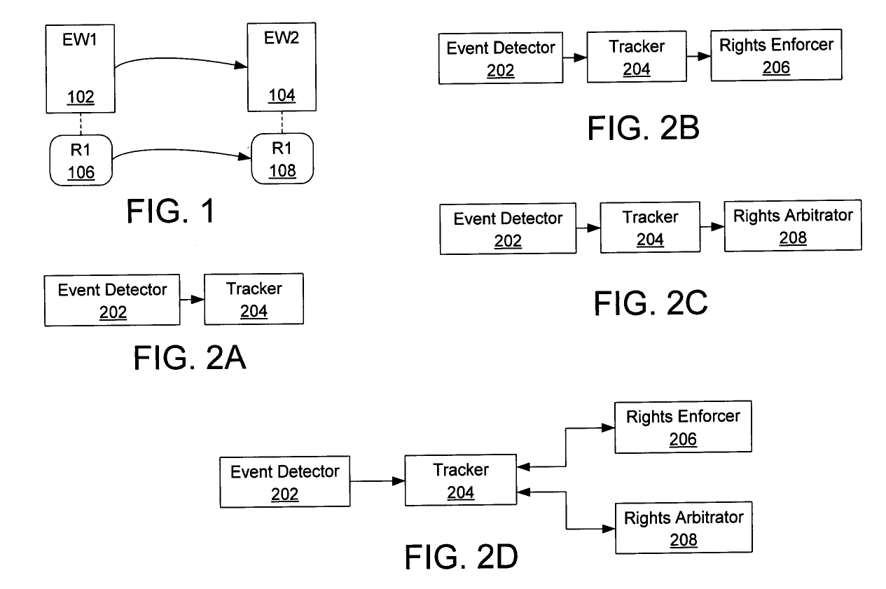

FIG. 1 illustrates generation of a derivative electronic work, wherein appropriate rights can be determined for and associated with the derivative electronic work. In FIG. 1, an electronic work 102 has rights 106 associated therewith. The rights 106 are bound to the electronic work 102, usually as of the moment the work 102 is generated. If a derivative electronic work 104 is generated, appropriate rights 108 can be determined and associated for the derivative work.

Accordingly, in FIG. 1, EW1 represents the existing electronic work 102 to which the rights 106, represented by R1, are associated. If EW1 is altered in any suitable way, including duplicating or modifying associated file data, the electronic work 102 now becomes the derivative work 104, represented by EW2. As EW2 is no longer the same electronic work as EW1, the rights 108, represented by R2, associated with EW2 might need to be altered from its original rights 106.

While derivative works can be created by modifying the content of the original digital work, the derivative works also can be created by changing other aspects of the original digital work, such as the filename used to store the original digital work or any other suitable data (e.g., author, modification date, last access time) that might be associated with the original digital work. For example, if a user were to perform file duplication for creating a duplicate of a pre-existing electronic work, and then were to assign a new filename to the duplicated work, this would be considered a derivative work.

In further examples, a derivative work might be created from two electronic works by copying a portion of one of the electronic works and pasting it into the other electronic work. A derivative work also might be created by adding new content to an existing electronic work. A derivative work also might be created by quoting or excerpting from an existing electronic work. A derivative work also might be created by superimposing two existing electronic works. A derivative work might also be created by reversing, re-coloring or resizing an electronic work.

Digital Rights Management (DRM) can take many forms and can be implemented in a variety of ways. A common aspect of protecting a work through the use of DRM is to determine and associate usage rights to the work. Such rights can be used to express who may use the work, how the work may be used, and the like. Rights can be expressed in many ways ranging from binary digits or flags to human readable syntax. Examples of expressing rights using binary digits or flags include the Broadcast Flag, DTCP and DPSA Copy Control Information (CCI), SMPTE Extended Content Control Information (ExCCI), TV-Anytime Rights Management and Protection Information (RMPI), and the like. Examples of a human readable way of expressing rights include XrML (eXtensible rights Markup Language), the ISO MPEG Rights Expression Language (MPEG REL), the Open Digital Rights Language (ODRL), the Open Mobile Alliance (OMA) REL, the Content Reference Forum Contract Expression Language (CRF CEL), the Security Assertion Markup Language (SAML), the XML Access Control Language (XACL), the eXtensible Access Control Markup Language (XACML), and the like. The exemplary embodiments place no requirements on how rights are specified, whereby any and all suitable means of expressing rights are valid and can be employed with the exemplary embodiments.

The exemplary embodiments include making available rights and origin-related information associated with various pieces of a derivative work, including detecting and tracking information associated with events that change electronic works. The exemplary embodiments further include maintaining or adapting rights associated with an electronic work, when any suitable content of the work is modified or transferred into another electronic work, including assessing, modifying or assigning rights to a derivative work by using the information made available concerning the components of the derivative work, their respective origins, and their associated rights. The exemplary embodiments further include enforcing rights to make derivatives of electronic works, including utilizing the information made available to determine the rights that apply to source material for a derivative work, and allowing the derivative work to be created, if the respective rights permit the respective derivations, and disallowing the derivative work to be created, if the respective rights do not permit the respective derivations.

FIGS. 2A-2D illustrate exemplary systems for adapting rights for derivative works corresponding to the above-described exemplary embodiments. In FIGS. 2A-2D, each logical module 202-208 can be implemented as one or more software and/or hardware components. One or more modules 202-208 can be combined into a single software and/or hardware component, and multiple software and/or hardware components can share the responsibility of implementing the modules 202-208.

An Event Detector 202 is responsible for monitoring, receiving or otherwise intercepting any suitable events that can result in the modification or movement of an electronic work. The Event Detector 202 can notify a Tracker 204 module that the event occurred, and provide the appropriate information regarding the event, including any suitable rights and origin information or information that can be used to reference rights and origin information at a later time.

There are many types of events that might occur, ranging from a simple key press to a more complex event, such as the merging of content between two electronic works. For example, in the case of copy-paste, the Event Detector 202 can let the Tracker 204 know which electronic work the pasted item came from, which electronic work the pasted item got pasted into, and, if applicable, what rights were associated with the pasted item. Additionally, in order for the Tracker 204 to maintain what happened with each event, support information can be employed. If, for example, a user presses a key while editing the electronic work, the Tracker 204 can track what key was pressed, and whether the additional character generated by the key was inserted into existing text or replaced existing highlighted text. In addition, the Tracker 204 can track where in the electronic work the insertion or replacement occurred. The information the Event Detector 202 passes to the Tracker 204 will likely need to vary with each event and is dependent on the needs of the particular implementation in which the exemplary embodiments are employed. The information collected by the Event Detector 202 can be made available to other logical modules.

The Tracker 204 is responsible for maintaining information that a Rights Arbitrator 208 can use to determine rights associated with a particular event or piece of content. There are numerous ways to keep track of such information. For example, the Tracker 204 can maintain a history of rights associated with each element of content that is added, inserted, merged, deleted or otherwise modified within an electronic work. In another example, the Tracker 204 can record the origin information along with each event that modifies an electronic work, maintaining a history and relationships of what modifications were made, what the origin of each modification is, and where, how and when each modification was made to the overall electronic work and by whom. The Tracker 204 can even take advantage of other software or services to assist in tracking the noted information, such as storing rights or origin and event related data in a system clipboard or a system controlled database. The exemplary embodiments do not limit themselves to a particular method of achieving such functionality.

The Tracker 204 can immediately notify the Rights Arbitrator 208 whenever the Tracker 204 receives an event that should be handled or the Tracker 204 can wait for the Rights Arbitrator 208 to request one or more items from a history maintained by the Tracker 204. The exemplary embodiments include notifying the Rights Arbitrator 208 immediately, as in an “immediate assessment” or and “eager assessment,” and waiting for the Rights Arbitrator 208 to request the information, as in a “deferred assessment” or a “lazy assessment.”

An immediate assessment typically can be used when the Rights Arbitrator 208 wishes to assess rights for each operation as operation occurs. A deferred assessment allows for system optimization, such as by the Tracker 204 consolidating information so that the information can be presented in more meaningful chunks to the Rights Arbitrator 208. A deferred assessment also can be used to resolve the rights associated with events or modifications all at one time, such as when the electronic work is being saved or in an asynchronous mode, such as might be required in a multi-threaded software product.

When the Rights Arbitrator 208 determines the derivative rights to apply to a derivative work, such derivative rights can fed back into the Tracker 204 module so that the derivative rights can be made available later. For example, the derivative rights could be useful for subsequent derivations. In another example, a Rights Enforcer 206 can allow or deny a derivation, depending on what the derivative rights would be. For example, the original rights might require that the derivative rights be more restrictive or at least not less restrictive than the original rights.

The information maintained by the Tracker 204 also can be made available to the Rights Enforcer 206 to allow the Rights Enforcer 206 to determine if the derivation is permitted. The Rights Enforcer 206 can issue a decision to allow the derivation or to cause a rollback. When an application or operating system sees a rollback decision from the Rights Enforcer 206, the application or operating system can halt further processing of the derivation event, and rollback changes. The allow/rollback decision also can be input to the Tracker 204, so that the Tracker 204 can reflect the decision in an internal database thereof for future use. The information maintained by the Tracker 204 also can be made available to other logical modules.

The Rights Arbitrator 208 is responsible for creating, altering or removing rights associated with a derivative work, in order to respect the rights of all suitable content associated with the derivative work. For example, if content is transferred into a derivative work, the Rights Arbitrator 208 is responsible for ensuring that the rights associated with the derivative work are considered along with any suitable rights that might have been assigned to the content being transferred.

To achieve such functionality, the Rights Arbitrator 208 assesses the rights of any suitable content or action related to the modification of an electronic work, based on the information provided by the Tracker 204. For example, if an image is pasted into a document, the Rights Arbitrator 208 can determine any suitable rights that might be associated with the image. If the user enters additional text into the document, the Rights Arbitrator 208 can determine whether the new text should have rights associated with therewith. If the user deletes or otherwise modifies existing content within an electronic work, the Rights Arbitrator 208 can determine how to modify the existing rights, if at all, to ensure the rights still are appropriate to the modified content.

Assessing rights in such a manner can include employing a very specific set of rules that might differ for each implementation. For example, one implementation might find it acceptable to append the rights of the transferred or modified content to that of the derivative work, letting a rights interpreter resolve any potential conflicts. Other implementations might employ a more complex assessment process that results in a clear set of rights that respect the transferred or modified content along with any suitable rights associated with the derivative work.

One approach that can be used by the Rights Arbitrator 208 to resolve rights arbitration is the concept of a “threshold.” If a user starts to modify the content of a protected electronic work, the Rights Arbitrator 208 might need to determine how much modification is necessary before the rights associated with the electronic work must be modified. The Rights Arbitrator 208 can be implemented in such a way that changing even a single character of the content might alter the associated rights. In another example, the Rights Arbitrator 208 can be implemented so that more than three words must be modified. Each specific implementation can implement the Rights Arbitrator 208 so that is it capable carrying out the process of making such determinations. The Rights Arbitrator 208 also can be responsible for executing the orders, wherein the actual orders are specified in the rights of the original materials issued by the original rights holders.

Implementations of a Rights Arbitrator 208 can be very careful with respect to relaxing rights that were previously associated with the original electronic work. For example, removal or lessening of restrictions, if not done correctly, can enable piracy or theft of protected content. Accordingly, a possible rule might be to remove or lessen restrictions, if the owner of the electronic content trusts the service running the Rights Arbitrator 208 to do so. Such a trust can be specified and enforced using, for example, rights expression languages.

Arbitrating the rights of the derivative work might be very simple or very complicated, depending on how the rights are specified or determined for the derivative work and the content transferred into or modified within the derivative work. For example, if a paragraph of text is appended to the end of a digital work, it might be a simple matter of appending additional rights to the derivative work in order to maintain the rights associated with the new paragraph. If, however, the paragraph is inserted into an existing rights-governed paragraph within the derivative work, determining how to modify the rights of the new composite paragraph might require more drastic steps, possibly including restructuring the rights of the old paragraph in order to effectively respect the rights associated with both the new and old text.

For example, if the old paragraph is only viewable during the year 2005, and the new paragraph is only viewable on Mondays, but provides that derivative thereof may be used anytime for $3, the arbitrator process might result in that the new composite paragraph can be used on Mondays in 2005 for free or any day in 2005 for $3.

In the case of a digital movie with rights that allow the local film crew to edit the content of the movie, if an editor appends credits or other material to the end of the movie, and the rights of the new frames are identical to that of the original digital movie, the rights may not need to be altered at all. If however, the rights of the frames are different than the rights of the new derivative work, the Rights Arbitrator 208 may need to alter or restructure the rights so that the rights of the new frames and the rights of the original electronic work can be effectively maintained. The Rights Arbitrator 208 may decide to alter the rights associated with the original digital movie to specify the frame numbers within the digital movie to which the associated rights apply. By restructuring the rights so that they apply to a specific range of frames within the digital movie, the Rights Arbitrator 208 is afforded the ability to create, modify or remove rights on individual frames or frame ranges within the digital movie.

For example, assume that the original digital movie specifies that anyone can view the content of the digital movie, but only the editing staff of the studio can edit the content, and that such rights are structured to apply to the entire movie. Also assume that there are exactly 1,000,000 frames to the original digital movie, and that the editing staff from the studio edits the original digital movie to add 500,000 frames of ending credits to the movie. The ending credits for some reason specify the rights associated therewith as view only with no rights to edit. The Rights Arbitrator 208 in this case detects that the rights associated with the original digital movie and those of the credits being appended to the movie are not the same. The Rights Arbitrator 208 can try to create a union of rights and find an acceptable compromise, but in this example, the Rights Arbitrator 208 decides to restore the rights to allow both the original digital movie and the newly appended credits to maintain their exact specification of rights. To achieve this, the Rights Arbitrator 208 can restore the rights associated with the original digital movie to specify that the rights apply to frames 1 through 1,000,000. The rights associated with the appended credits are restored to specify that they apply to frames 1,000,0001 through 1,500,000. By restructuring the rights in this manner, the rights associated with the derivative work now maintain the exact rights for both the original digital movie and the appended credits with no compromise of rights.

The Rights Enforcer 206 in general is responsible for allowing or disallowing actions based on the associated rights. In an exemplary embodiment, the Rights Enforcer 206 is responsible for allowing or disallowing derivation actions upon an electronic work based on the associated rights. For example, if a derivation action is allowed upon an electronic work, then a derivative work is created. However, if a derivation action is disallowed upon an electronic work, then any derivative work made by that action needs to be rolled back or prevented from happening.

In order to determine whether a particular derivative work can be allowed or needs to be prevented, the Rights Enforcer 206 can rely on information about the electronic works from which the derivative work was derived and the manner in which such derivation took place. This information is made available as part of the change/adaptation history from the Tracker 204.

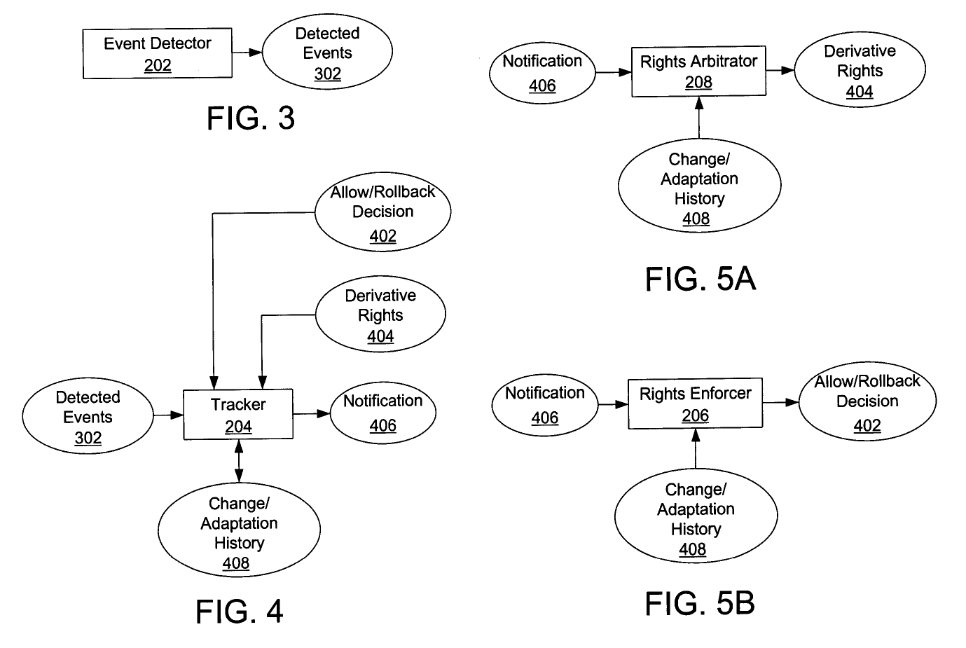

FIG. 3 is used to illustrate exemplary processes performed by an exemplary event detector of the exemplary systems of FIGS. 2A-2D. In FIG. 3, the Event Detector 202 generates detected events 302. FIG. 4 is used to illustrate exemplary processes performed by an exemplary event tracker of the exemplary systems of FIGS. 2A-2D. In FIG. 4, the Tracker 204 receives the detected events 302, allow/rollback decision 402, and derivative rights 404, communicates change/adaptation history 408, and generates notification 406. FIGS. 5A-5B are used to illustrate exemplary processes performed by an exemplary rights arbitrator and rights enforcer of the exemplary systems of FIGS. 2A-2D. In FIG. 5A, the Rights Arbitrator 208 receives the notification 406, accesses the change/adaptation history 408, and generates the derivative rights 404. In FIG. 5B, the Rights Enforcer 206 receives the notification 406, accesses the change/adaptation history 408, and generates the allow/rollback decision 402.

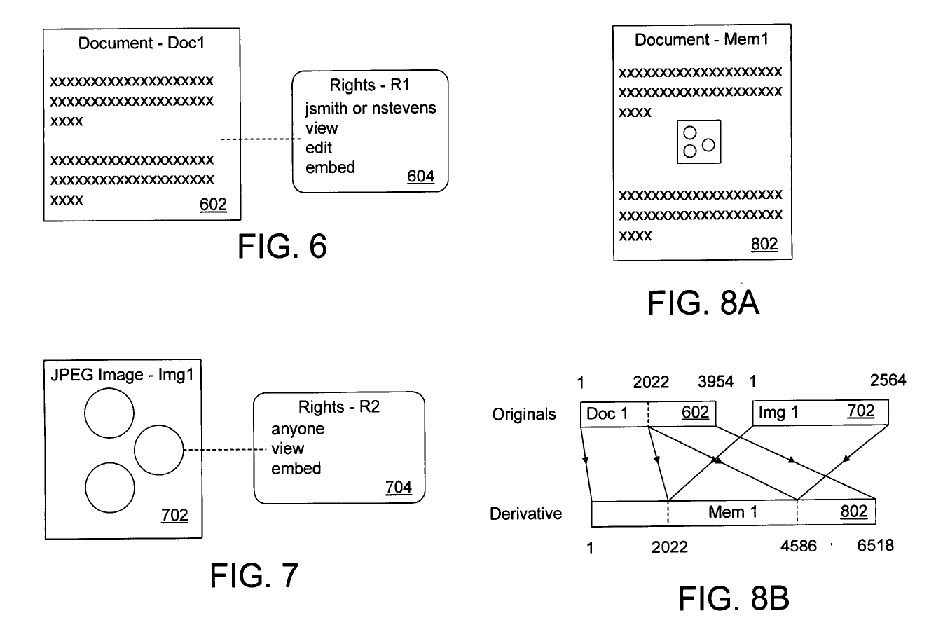

FIG. 6 is used to illustrate how rights are applied to an entire electronic document. In FIG. 6, an electronic work in the form of a document 602, Doc1, has rights 604, R1, associated therewith, and which state that J. Smith (jsmith) or N. Stevens (nstevens) can view or edit or embed the document 602. The rights 604 are simple and apply to the entire document 604.

FIG. 7 is used to illustrate how rights are applied to an entire electronic image. In FIG. 7, an electronic work in the form of an image 702, Img1, has associated rights 704, R2. The rights 704 specify that anyone can view the JPEG 702 or embed the JPEG 702 into other documents. The rights 704, however, conflict with the rights 604 associated with the document 602, wherein the rights 604 associated with the document 602 allow only jsmith and nstevens to view, edit and embed, but the rights 704 associated with the JPEG 702 allow everyone only the rights to view and embed.

FIGS. 8A-8B are used to illustrate embedding of the electronic image of FIG. 7 into the electronic document of FIG. 6. In FIG. 8A, nstevens attempts to embed the JPEG image into the document 602, resulting in a new document 802 stored in memory, Mem1. The Event Detector 202 can detect such an event and pass the event and information related to the event to the Tracker 204. Such information can be stored or recorded by the Tracker 204 in a manner that allows its retrieval at a later time. The following examples show how the Tracker 204 can record such information.

The following table shows data stored by the Tracker 204 using Origin Tracking Model before the image insert event:

| Work | Byte Range | | Action Timestamp | | Actor | Source | Source Byte Range | |
|---|---|---|---|---|---|---|---|---|
| ID | Start | End | Date | Time | ID | ID | Start | End |
| Doc1 | 1 | 3954 | 8/16/2004 | 12:30 | jsmith | original | N/A | N/A |
| Img1 | 1 | 2564 | 8/20/2004 | 9:47 | bjones | original | N/A | N/A |
| Mem1 | 1 | 3954 | 8/31/2004 | 15:20 | nstevens | Doc1 | 1 | 3954 |

The following table shows data stored by the Tracker 204 using Origin Tracking Model after the image insert event:

| Work | Byte Range | | Action Timestamp | | Actor | Source | Source Byte Range | |
|---|---|---|---|---|---|---|---|---|
| ID | Start | End | Date | Time | ID | ID | Start | End |
| Doc1 | 1 | 3954 | 8/16/2004 | 12:30 | jsmith | original | N/A | N/A |
| Img1 | 1 | 2564 | 8/20/2004 | 9:47 | bjones | original | N/A | N/A |
| Mem1 | 1 | 2022 | 8/31/2004 | 15:20 | nstevens | Doc1 | 1 | 2022 |
| Mem1 | 2023 | 4586 | 8/31/2004 | 15:21 | nstevens | Img1 | 1 | 2564 |
| Mem1 | 4587 | 6518 | 8/31/2004 | 15:20 | nstevens | Doc1 | 2023 | 3954 |

The following table shows data stored by the Tracker 204 using Rights Tracking Model before the image insert event:

| Work | Byte Range | | Action Timestamp | | Actor | Rights |
|---|---|---|---|---|---|---|
| ID | Start | End | Date | Time | ID | ID |
| Mem1 | 1 | 3954 | 8/31/2004 | 15:20 | nstevens | R1 |

The following table shows data stored by the Tracker 204 using Rights Tracking Model after the image insert event:

| Work | Byte Range | | Action Timestamp | | Actor | Rights |
|---|---|---|---|---|---|---|
| ID | Start | End | Date | Time | ID | ID |
| Mem1 | 1 | 2022 | 8/31/2004 | 15:20 | nstevens | R1 |
| Mem1 | 2023 | 4586 | 8/31/2004 | 15:21 | nstevens | R2 |
| Mem1 | 4587 | 6518 | 8/31/2004 | 15:20 | nstevens | R1 |

The byte ranges in the second and third columns in the tables above represent ranges within the work identified in the first column. The byte ranges in the last two columns in the tables above represent the location of the corresponding content within the identified source work. Such a relationship is shown in FIG. 8B.

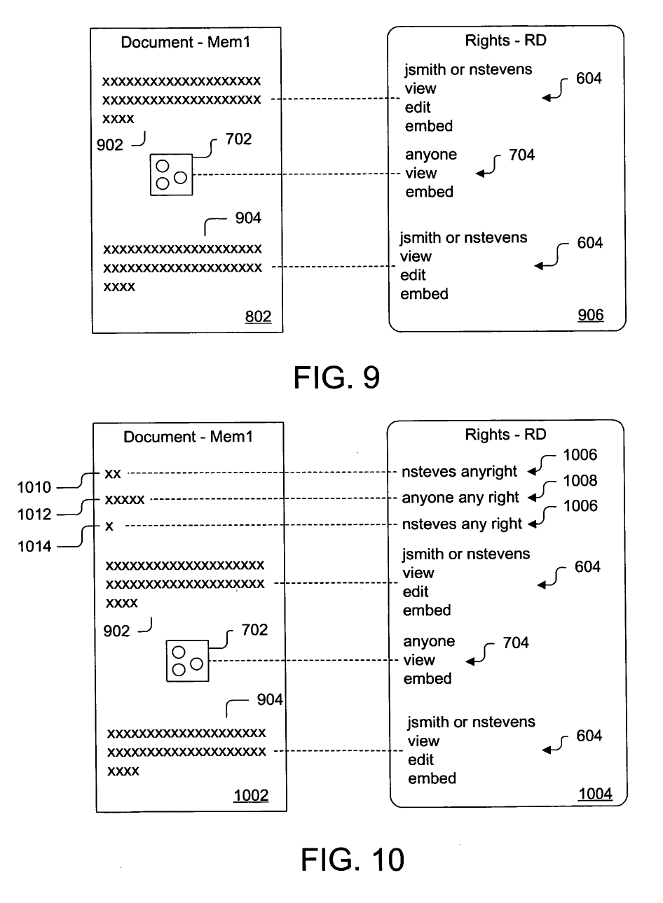

FIG. 9 is used to illustrate how derivative rights are generated for a derivative work corresponding to FIG. 6-8. In FIG. 9, at this point, if the system is operating in the Immediate Assessment Mode, the next step is to perform the rights arbitration, that is, to determine if there are any conflicts that need a resolution and to create, restructure or modify rights that will properly govern the content of the original document while maintaining the more and less restrictive rights of the image. To do this, the Rights Arbitrator 208 will look at the information available from the Tracker 204 to determine which rights are applicable to the derivate work 802 in memory and determine if there are any conflicts that need resolving. In this particular example, the conflict originates from the fact that the JPEG image 702 has the rights 704 that do not allow editing, while the document 802 does not allow everyone to view and insert. Each implementation can decide how to best resolve such conflicts. For this implementation example, the conflict can be solved by using a feature that exists within some rights expression languages, known as a composite work. In general terms, this feature enables logically breaking a document into multiple pieces for the purpose of assigning rights. In this example, the user wishes to insert the image 702 between the two illustrated paragraphs 902 and 904 in the document 802. Accordingly, the Rights Arbitrator 208 can logically treat the first paragraph 902, the inserted JPEG image 702, and the last paragraph 904, as separate pieces within a composite work 802 having derivative rights 906, including the set of rights 604 and 704.

Once the Rights Arbitrator 208 has resolved the conflict and created or modified the rights associated with the new derivative work 802, the Rights Arbitrator 208 can commit such rights 906, RD, to the derivative work 802, in order to properly govern the new derivative work 802.

If, however, the system is operating in Deferred Assessment Mode, the Rights Arbitrator 208 need not be invoked for each event, and several more events (in addition to the image insert event) can occur before the Rights Arbitrator 208 has to assess and assign rights to the derivative work. In this case, the Tracker 204 can keep track of such additional events as they occur.

FIG. 10 is used to illustrate how further derivative rights are generated for a derivative work based on FIG. 9. For example, consider the case where nstevens next adds to the document in memory a heading 1010 reading “My version of ‘Four score and seven years ago . . . ’”. He inputs the heading 1010 using the keyboard. He has specified the default rights 1006 in his document editing software to be applied to his original inputs as R3 (“nstevens may do anything”). However, The Gettysburg Address is in the public domain, so its quote 1012 should be assigned public domain rights 1008, R4, (“anyone may do anything”). The Tracker 204 can determine this information, for example, by comparing the text entered with a database of published electronic works. The following show different examples of how the Tracker 204 can record such information.

The following table shows data stored by the Tracker 204 using Origin Tracking Model after the keyboard input event (note that Input1 represents the keyboard input work and Doc2 represents The Gettysburg Address work):

| Work | Byte Range | | Action Timestamp | | Actor | Source | Source Byte Range | |
|---|---|---|---|---|---|---|---|---|
| ID | Start | End | Date | Time | ID | ID | Start | End |
| Doc1 | 1 | 3954 | 8/16/2004 | 12:30 | jsmith | original | N/A | N/A |
| Img1 | 1 | 2564 | 8/20/2004 | 9:47 | bjones | original | N/A | N/A |
| Input1 | 1 | 14 | 8/31/2004 | 15:25 | nstevens | original | N/A | N/A |
| Input1 | 15 | 45 | 8/31/2004 | 15:25 | nstevens | Doc2 | 1 | 30 |
| Input1 | 46 | 49 | 8/31/2004 | 15:25 | nstevens | original | N/A | N/A |
| Doc2 | 1 | 1525 | 11/19/1863 | 10:42 | alincoln | original | N/A | N/A |
| Mem1 | 1 | 49 | 8/31/2004 | 15:25 | nstevens | Input1 | 1 | 49 |
| Mem1 | 50 | 2071 | 8/31/2004 | 15:20 | nstevens | Doc1 | 1 | 2022 |
| Mem1 | 2072 | 4635 | 8/31/2004 | 15:21 | nstevens | Img1 | 1 | 2564 |
| Mem1 | 4636 | 6567 | 8/31/2004 | 15:20 | nstevens | Doc1 | 2023 | 3954 |

The following table shows data stored by Tracker 204 using Rights Tracking Model after the keyboard input event:

| Work | Byte Range | | Action Timestamp | | Actor | Rights |
|---|---|---|---|---|---|---|
| ID | Start | End | Date | Time | ID | ID |
| Mem1 | 1 | 14 | 8/31/2004 | 15:25 | nstevens | R3 |
| Mem1 | 15 | 45 | 8/31/2004 | 15:25 | nstevens | R4 |
| Mem1 | 46 | 49 | 8/31/2004 | 15:25 | nstevens | R3 |
| Mem1 | 50 | 2071 | 8/31/2004 | 15:20 | nstevens | R1 |
| Mem1 | 2072 | 4635 | 8/31/2004 | 15:21 | nstevens | R2 |
| Mem1 | 4636 | 6567 | 8/31/2004 | 15:20 | nstevens | R1 |

If the next event is the user saving the document in memory, such an event can trigger the Rights Arbitrator 208 to begin its process of assigning rights. The Rights Arbitrator 208 can do this as described above, except this time taking into account the additional information.

All the same information provided by the Tracker 204 and used by the Rights Arbitrator 208 at this stage can instead or additionally be used by the Rights Enforcer 206, for example, to determine if nstevens is permitted to even create the resultant derivative work 1002. The Rights Arbitrator 208 and the Rights Enforcer 206 are complementary in this regard. The Rights Enforcer 206 determines if the derivative work 1002 can be created, while the Rights Arbitrator 208 determines what rights 1004 should be assigned to the derivative work 1002 once it is created.

In this case, if the Rights Enforcer 206 is called to determine if the save of the derivative work 1002 in Mem1 at the end of the above process is to be permitted, the Rights Enforcer 206 can inspect the output of the Tracker 204. The Rights Enforcer 206 would discover that Mem1 includes new text 1010 embedded from the keyboard with rights 1006, R3, a quote 1012 from The Gettysburg Address with rights 1008, R4, an embedded image 702 with rights, 704, R2, and an edited document 802 with rights 604, R1. The Rights Enforcer 206 then can verify that rights 1006, R3, permit nstevens to embed the text 1010 from the keyboard. Since R3 permits nstevens to do any rights, this verification succeeds. The Rights Enforcer 206 then can verify that rights 1008, R4, permit nstevens to quote 1012 The Gettysburg Address. Since rights 1008, R4, permit anyone to do any rights, this verification succeeds. The Rights Enforcer 206 then can verify that rights 704, R2, permit nstevens to embed the image. Since rights 704, R2, permit anyone to embed the image, this verification succeeds. The Rights Enforcer 206 then can verify that rights 604, R1, permit nstevens to edit the document. Since rights 604, R1, permit either jsmith or nstevens to edit the document, this verification succeeds. Since all source electronic works have rights permitting their respective derivation actions, the Rights Enforcer 206 allows the derivative work 1002 to be created with associated derivative rights 1004.

The Rights Enforcer 206 and Rights Arbitrator 208 can proceed in any order or in parallel. If the Rights Enforcer 206 finishes first and determines the derivation is to be rolled back, it could save the Rights Arbitrator 208 time figuring out what rights to apply to a derivative work that will not exist. On the other hand, if the Rights Enforcer 206 encounters derivation rights on the source electronic works that depend on what the rights to the derivative work would be, the Rights Enforcer 206 can wait for the Rights Arbitrator 208 to finish first.

The following usage scenarios illustrate exemplary applications of the exemplary embodiments. With respect to a System Clipboard application, the exemplary embodiments can be realized as an alteration to the existing concept of the system clipboard used to copy and paste content between images, where the Tracker 204 and the Rights Arbitrator 208 store and retrieve rights related information about each piece of content copied or pasted into or out of an electronic work. The system clipboard can be modified so that, in addition to storing an image, text or other content, associated data, such as rights or origin and event information related to the content, can be stored and retrieved along with the content.

In this implementation, a user can copy an image from a protected work, which in many modem operating systems places the image into a storage area referred to as the clipboard. If the clipboard concept were altered so that, in addition to the content, information related to the content also can be stored, the Tracker 204 can use such capability to store rights or origin and event information, as described in the following usage scenario, and the Rights Arbitrator 208 then can retrieve such information when needed, such as when the user attempts to paste the content into another document.

With respect to a Document Editor application, the exemplary embodiments can include a document editor software application, similar to Microsoft Word. Like Microsoft Word, such an application can handle creating, inserting, appending, modifying or replacing text and other content within a document. Standard copy, cut and paste events also can be supported. In addition, the document editor can allow a user to specify rights associated with any suitable new material the user enters into the document.

For simplicity, consider a user creating a new electronic work and typing text into it. The logical modules 202-208 of the exemplary embodiments then could immediately come into play. The Event Detector 202 can begin detecting or intercepting any suitable event that can potentially alter the electronic work. In this case, the Event Detector 202 can detect that the user has pressed a key on the keyboard with the intent to add a single character into the electronic work. The Event Detector 202 then can notify the Tracker 204 that such a key was pressed, as well as any suitable related information the Event Detector 202 has about the event, such as what key the user pressed. The Tracker 204 then can record information about such an event in order to preserve a history of all such activity. For example, the Tracker 204 can keep track of such information in a local database file. Such an exemplary implementation of the document editor has been designed to handle rights assessment immediately, rather than in a later stage. As such, the Tracker 204 then notifies the Rights Arbitrator 208 that the Tracker 204 has recorded an event and makes information regarding the event available. The Rights Arbitrator 208 looks at the event, in this case a single key press on the keyboard, and notes that the document editor is setup to assign a default set of rights to all suitable new text entered into the document. If, for example, the rights specify that anyone can view the electronic work, but any other operation on the electronic work is prevented, the Rights Arbitrator 208 assigns such rights to the character entered into the electronic work and the process repeats, assigning rights to all new content within the document in the same manner. While it might be unlikely that rights would be assigned to individual characters in a document, the Rights Arbitrator 208 can combine individual characters into an entire work or individual sentences or paragraphs and assign or reassign rights to such larger content entities. As the user enters new content, such content is assigned with rights. The rights continue to evolve or change as new content is entered. The user can now choose to save the document or electronic work.

Sometime later, the same user opens the same derivative work in order to add an electronic image he has obtained from another service. The electronic image has already been assigned its own rights. The user uses the document editor to open the image and insert it into the middle of the existing text. Once again the Event Detector 202 detects or intercepts the attempt to modify the electronic work, notifies the Tracker 204, which records information about the event, and makes available the related information to the Rights Arbitrator 208, notifying it to take action. This time, the Rights Arbitrator 208 notes that the electronic image already has its own rights which specify anyone may view or print the electronic image. The Rights Arbitrator 208, in assessing the rights of both the electronic image being inserted, and the previously saved text, notes that the rights specified for each are different. The previously saved text only allows someone to view the text, not print. The Rights Arbitrator 208 can now arbitrate the rights in a way that achieves the goals for the specific implementation. There are multiple ways of resolving such a conflict. In one extreme, the Rights Arbitrator 208 can decide to alter the rights of the text or acquire more rights to the text to match that of the image. In another extreme, the Rights Arbitrator 208 can alter the rights on the image to the more restrictive set of rights specified by the text. The Rights Arbitrator 208 in this example can decide to restructure the rights so as to maintain the exact effect of the rights specified for the text and the image. Since the image is being inserted into the center of the text, the Rights Arbitrator 208 restructures the rights of the electronic work to treat the text above the image, the text below the image, and the image itself as separate entities within the document and rights specification. In other words, the Rights Arbitrator 208 assigns the right for anyone to view to the text above the image, separate from the others. The Rights Arbitrator 208 then creates a new set of rights that apply to the image that allows anyone to view and print the image. Finally, the Rights Arbitrator 208 assigns yet another set of rights to the text below the image, to maintain the effect of the rights that anyone can view the text. The conflict created when inserting content that has rights that are different or even conflict with rights already within the document is the domain of the Rights Arbitrator 208. Each implementation can choose to handle the same conflict in a different way and different users can have different preferences. In this usage scenario, the implementation chose to go to great lengths to maintain the exact effect of the rights of each component within the electronic work. Another implementation can decide it is adequate to take the greatest common denominator approach and alter the rights of the image so that anyone can view, but not print the image. Accordingly, the Rights Arbitrator 208 can be tailored to each implementation in order to carry out the goals of the respective implementation or user.

If this same document editor were implemented to utilize “deferred assessment” of rights, the process described above can be used, with the exception that the Rights Arbitrator 208 need not handle each event as it occurs. Instead, the Rights Arbitrator 208 can defer the assessment and assignment of rights until a specific trigger defined by the implementation. Such a trigger can be an event, such as saving the derivative work or might be implemented to work in batch, assessing and assigning rights once a specific number of events have occurred. Each implementation can decide the event that triggers the rights assessment in a deferred assessment to meet given needs or requirements.

With respect to a Rights Assignment through Comparison application, building on the usage case scenario of a document editor, the same implementation described in that usage scenario can be taken a step further. Since all suitable keystrokes and content being added or inserted into the electronic work are being monitored, the document editor can be augmented to compare any suitable text or content entered into the electronic work with a database or other storage of existing protected works. In other words, as the user enters content into the electronic work, the document editor, through the data maintained by the Tracker 204, can allow the Rights Arbitrator 208 to compare the content to other protected content with the intent to determine if any materials added, inserted or otherwise transferred into the electronic work are already protected. If a match is found, the Rights Arbitrator 208 can automatically assign rights to the content in order to properly protect the prior work.

An example of this could be a user typing a term paper. The user unknowingly or perhaps willingly, enters a quote of a famous literary work. This implementation might consult a collection of other protected works, determine the text entered is from some famous literary work, and notify the user or automatically assign the appropriate right to the quote, based on the rights specified for the associated famous literary work.

Once again, utilizing the Document Editor usage scenario case, a software application can choose to utilize the information maintained by the Tracker 204, without ever assigning rights to the derivative work. In this scenario, the Event Detector 202 and Tracker 204 work as described by the Document Editor scenario, but the Rights Arbitrator 208 is not used. Such an implementation obtains from the Tracker 204 the information about all the suitable original works that went into creating the derivative work, wherein this is different from simply understanding the users who edited the work over its lifetime. The information about all the suitable original works then can be used to generate a credits list to be appended to the final document.

In addition to being able to be used to generate a list of credits, the Tracker 204 information can be used by a rights enforcement module. The idea of a rights enforcement module is well-known in the DRM industry. Such a module is responsible for ensuring that a resource is used only in accordance with any applicable rights. Some such rights can be rights to perform adaptations. For example, an image can have an associated rights expression permitting its embedding into an article. A dissertation can have an associated rights expression permitting it to be quoted in an article. A user can copy the image to a clipboard, paste the image into an image editing application, copy a piece of text from the dissertation to a clipboard, paste the text into an image editing application, center the text under the image, copy the resulting composite to the clipboard, paste the composite into an article, and finally save the article. At this time the rights enforcement module can query the Tracker 204 module to determine that the article in memory to be saved includes the original article, the image, and a quote from the dissertation. The rights enforcement module then can use this information to determine that it needs to check for rights to adapt the article, embed the image, and quote the dissertation, before allowing the revised article to be saved.

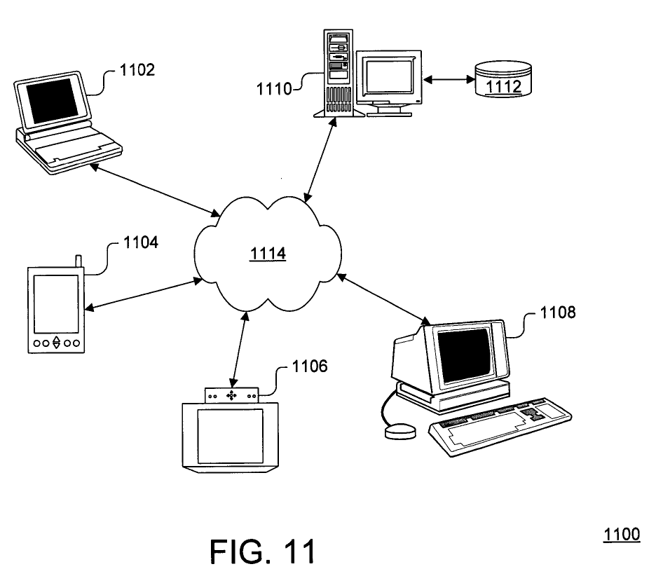

FIG. 11 illustrates an exemplary system for adapting rights for derivative works and which can be used with the exemplary embodiments of FIGS. 1-10. In FIG. 11, the exemplary system 1100 can include one or more devices 1102-1108, a content server 1110, and content database 1112, coupled together via a communications network 1114. One or more of the devices 1102-1112 can be used to implement the exemplary embodiments of FIGS. 1-10.

The above-described devices and subsystems of the exemplary embodiments of FIGS. 1-11 can include, for example, any suitable servers, workstations, PCs, laptop computers, PDAs, Internet appliances, handheld devices, cellular telephones, wireless devices, other devices, and the like, capable of performing the processes of the exemplary embodiments of FIGS. 1-11. The devices and subsystems of the exemplary embodiments of FIGS. 1-11 can communicate with each other using any suitable protocol and can be implemented using one or more programmed computer systems or devices.

One or more interface mechanisms can be used with the exemplary embodiments of FIGS. 1-11, including, for example, Internet access, telecommunications in any suitable form (e.g., voice, modem, and the like), wireless communications media, and the like. For example, the communications network 714 can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the exemplary embodiments of FIGS. 1-11 are for exemplary purposes, as many variations of the specific hardware used to implement the exemplary embodiments are possible, as will be appreciated by those skilled in the relevant art(s). For example, the functionality of one or more of the devices and subsystems of the exemplary embodiments of FIGS. 1-11 can be implemented via one or more programmed computer systems or devices.

To implement such variations as well as other variations, a single computer system can be programmed to perform the special purpose functions of one or more of the devices and subsystems of the exemplary embodiments of FIGS. 1-11. On the other hand, two or more programmed computer systems or devices can be substituted for any one of the devices and subsystems of the exemplary embodiments of FIGS. 1-11. Accordingly, principles and advantages of distributed processing, such as redundancy, replication, and the like, also can be implemented, as desired, to increase the robustness and performance the devices and subsystems of the exemplary embodiments of FIGS. 1-11.

The devices and subsystems of the exemplary embodiments of FIGS. 1-11 can store information relating to various processes described herein. This information can be stored in one or more memories, such as a hard disk, optical disk, magneto-optical disk, RAM, and the like, of the devices and subsystems of the exemplary embodiments of FIGS. 1-11. One or more databases of the devices and subsystems of the exemplary embodiments of FIGS. 1-11 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1-11 can include appropriate data structures for storing data collected and/or generated by the processes of the devices and subsystems of the exemplary embodiments of FIGS. 1-11 in one or more databases thereof.

All or a portion of the devices and subsystems of the exemplary embodiments of FIGS. 1-11 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. Further, the devices and subsystems of the exemplary embodiments of FIGS. 1-11 can be implemented on the World Wide Web. In addition, the devices and subsystems of the exemplary embodiments of FIGS. 1-11 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1-11, for driving the devices and subsystems of the exemplary embodiments of FIGS. 1-11, for enabling the devices and subsystems of the exemplary embodiments of FIGS. 1-11 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the invention. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1-11 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of exemplary embodiments and implementations, the present invention is not so limited but rather covers various modifications and equivalent arrangements, which fall within the purview of the appended claims.

1. A method for handling creation of derivative works and for assigning usage rights to the derivative works to be used within a system for enforcing usage rights associated with digital works, the method comprising:
detecting computer-related events that are indicative of manipulations of an original work for creating a derivative work;
maintaining a history of information, including at least one of rights associated with electronic content related to each of the events, origin of electronic content related to each of the events, and event related information that can be used to determine the origin of and rights associated with electronic content;
determining usage rights for the content of the derivative work based on information related to the detected computer-related events; and
assigning the usage rights determined in the determining step to at least a portion of the content of the derivative work, the assigned usage rights being enforceable to control use of the portion of the content of the derivative work.

2. The method of claim 1,
wherein the determining step comprises monitoring event related information that can be used to track creation or modification of the electronic content.

3. The method of claim 2, further comprising:
arbitrating rights between the original work and rights of the derivative work;
determining a set of usage rights that honor the rights of both the original work and the derivative work to determine the usage rights for the content of the derivative work; and
associating the set of rights with the derivative work;
wherein the original work can include another derivative work.

4. The method of claim 3, further comprising enforcing of rights associated with an action for deriving the derivative work.

5. The method of claim 4, wherein the enforcement step occurs after the arbitration and association steps.

6. The method of claim 4, wherein the enforcement step occurs before at least one of the arbitration and association steps.

7. The method of claim 2, wherein the determining step comprises determining rights related to digital content taken from the original work to create the derivative work.

8. The method of claim 2, wherein the determining step comprises determining rights related to the original work from which the derivative work is created.

9. The method of claim 2, wherein the determining step comprises determining rights related to the computer-related events.

10. The method of claim 3, wherein the assigning step comprises designating the set of usage rights to be associated with the derivative work.

11. The method of claim 2, wherein the detecting step comprises one of intercepting, trapping, and detecting the computer-related events.

12. The method of claim 2, further comprising one of recording and maintaining a history associated with at least one of the computer-related events, the determined usage rights, and rights associated with content related to each of the computer-related events.

13. A computer system comprising one or more computer processors configured to execute the steps recited in claim 1.

14. A computer program product comprising one or more computer-readable instructions configured to cause one or more computer processors to execute the steps recited in claim 1.

15. A system for handling creation of derivative works and for assigning usage rights to the derivative works for enforcing usage rights associated with digital works, comprising:
means for detecting computer-related events that are indicative of manipulations of an original work for creating a derivative work;
means for maintaining a history of information, including at least one of rights associated with electronic content related to each of the events, origin of electronic content related to each of the events, and event related information that can be used to determine the origin of and rights associated with electronic content;
means for determining usage rights for content of the derivative work based on information related to the detected computer-related events; and
means for assigning the usage rights determined in the determining step to at least a portion of the content of the derivative work the assigned usage rights being enforceable to control use of the portion of the content of the derivative work.

16. The system of claim 15,
wherein the determining means comprises means for monitoring event related information that can be used to track creation or modification of the electronic content.

17. The system of claim 16, further comprising:
means for arbitrating rights between the original work and rights of the derivative work;
means for determining a set of usage rights that honor the rights of both the original work and the derivative work to determine the usage rights for the content of the derivative work; and
means for associating the set of rights with the derivative work;
wherein the original work can include another derivative work.

18. The system of claim 17, further comprising means for enforcing of rights associated with an action for deriving the derivative work.

19. The system of claim 18, wherein the enforcement means enforces the rights after the arbitration means arbitrates the rights and the association means associates the set of rights.

20. The system of claim 18, wherein the enforcement means enforces the rights before at least one of the arbitration means arbitrates the rights and the association means associates the set of rights.

21. The system of claim 16, wherein the determining means comprises means for determining rights related to digital content taken from the original work to create the derivative work.

22. The system of claim 16, wherein the determining means comprises means for determining rights related to the original work from which the derivative work is created.

23. The system of claim 16, wherein the determining means comprises means for determining rights related to the computer-related events.

24. The system of claim 17, wherein the assigning means comprises means for designating the set of usage rights to be associated with the derivative work.

25. The system of claim 16, wherein the detecting means comprises one of means for intercepting, means for trapping and means for detecting the computer-related events.

26. The system of claim 16, further comprising means for one of recording and maintaining a history associated with at least one of the computer-related events, the determined usage rights, and rights associated with content related to each of the computer-related events.

27. The system of claim 16, wherein the arbitrating means, the determining means, and the associating means comprise one or more hardware and/or software devices of a computer system.

28. A device for handling creation of derivative works and for assigning usage rights to the derivative works to be used within a system for enforcing usage rights associated with digital works, the device comprising:
means for detecting computer-related events that are indicative of manipulations of an original work for creating a derivative work;
means for maintaining a history of information, including at least one of rights associated with electronic content related to each of the events, origin of electronic content related to each of the events, and event related information that can be used to determine the origin of and rights associated with electronic content;
means for determining usage rights for content of the derivative work based on information related to the detected computer-related events; and
means for assigning the usage rights determined in the determining step to at least a portion of the content of the derivative work, the assigned usage rights being enforceable to control use of the portion of the content of the derivative work;
wherein the determining means comprises means for monitoring event related information that can be used to track creation or modification of the electronic content.

29. (canceled)

30. The device of claim 28, further comprising:
means for arbitrating rights between the original work and rights of the derivative work;
means for determining a set of usage rights that honor the rights of both the original work and the derivative work to determine the usage rights for the content of the derivative work; and
means for associating the set of rights with the derivative work;
wherein the original work can include another derivative work.

31. The device of claim 30, further comprising means for enforcing of rights associated with an action for deriving the derivative work.

32. The device of claim 31, wherein the enforcement means enforces the rights after the arbitration means arbitrates the rights and the association means associates the set of rights.

33. The device of claim 31, wherein the enforcement means enforces the rights before at least one of the arbitration means arbitrates the rights and the association means associates the set of rights.

34. The device of claim 28, wherein the determining means comprises means for determining rights related to digital content taken from the original work to create the derivative work.

35. The device of claim 28, wherein the determining means comprises means for determining rights related to the original work from which the derivative work is created.

36. The device of claim 28, wherein the determining means comprises means for determining rights related to the computer-related events.

37. The device of claim 30, wherein the assigning means comprises means for designating the set of usage rights to be associated with the derivative work.

38. The device of claim 28, wherein the detecting means comprises one of means for intercepting, means for trapping and means for detecting the computer-related events.

39. The device of claim 28, further comprising means for one of recording and maintaining a history associated with at least one of the computer-related events, the determined usage rights, and rights associated with content related to each of the computer-related events.

40. The device of claim 28, wherein the arbitrating means, the determining means, and the associating means comprise one or more hardware and/or software devices of a computer system.
